(19) United States
(12) Patent Application Publication
(10) Pub. No.: US 2025/0057262 A1
(43) Pub. Date: Feb. 20, 2025

(54) WEARABLE SAFETY SYSTEM AND A BAG ARRANGEMENT USING SUCH WEARABLE SAFETY SYSTEM

(71) Applicant: Autoliv Development AB, Vargarda (SE)

(72) Inventors: Alexander RIESS, Alingsas (SE); Mikaela HAGG, Vargarda (SE); Sara STROM, Vargarda (SE); Rebecca MAGYAR, Vargarda (SE)

(21) Appl. No.: 18/720,997

(22) PCT Filed: Nov. 17, 2022
(86) PCT No.: PCT/EP2022/082205

§ 371 Date: Jun. 17, 2024

(30) Foreign Application Priority Data
Dec. 20, 2021 (EP) 21216088.1

(51) Int. Cl. A41D 13/018

(52) U.S. Cl. CPC A41D 13/018

(57) ABSTRACT

A wearable safety system comprising a harness comprising a back protection panel, two shoulder straps and a hip belt. The harness is configured to be worn on the torso of a wearer. The system further comprises at least one inflator; and at least one airbag. The wearable safety system is configured to generate an activation signal upon detection of an accident. The at least one airbag is configured to be inflated upon the generation of the activation signal and to be deployed to form at least one inflated body having an extension across at least one of the head and shoulders of the wearer, the thorax area of the wearer and the hips of the wearer. Further, a bag arrangement is provided.

### TECHNICAL FIELD

The present invention relates to a wearable safety system and a bag arrangement using such wearable safety system.

### TECHNICAL BACKGROUND

It is well known in the art to provide wearable safety systems such as helmets and different kinds of rigid or semi-rigid protections for shoulders, the back, elbows, hips etc. These wearable safety systems are however typically experienced as being bulky. This may be a hinder or be used as an excuse to not use the safety system and especially in combination with other common equipment such as a backpack or a bag. However, if worn, severe injuries could be hindered or reduced, especially among active people, no matter if it comes to commuting, construction work, outdoor activities or even extreme sports. There is hence a need for further improvements of wearable safety systems and especially the provision of a wearable safety system that is more user friendly during normal activity.

### SUMMARY OF THE INVENTION

It is an object of the present invention to overcome the above-described drawbacks, and to provide an improved wearable safety system.

Another object is to provide a wearable safety system that is easy combinable with a bag.

Yet another object is to provide a wearable safety system that, in the event of an accident can be deployed and selectively form a protection for the head and shoulders, the thorax area and the hips.

These and other objects that will be apparent from the following summary and description are achieved by a wearable safety system according to the appended claims.

According to an aspect of the present invention, there is provided a wearable safety system, comprising:
a harness comprising a back protection panel, two shoulder straps and a hip belt, said harness being configured to be worn on the torso of a wearer; wherein
the back protection panel is formed by a rigid material and has an extension along the longitudinal extension of a back wall of the harness;
the back protection panel supports at least one inflator, an ECU and a battery, said ECU being arranged in communication with the at least one inflator;
the at least one inflator is received in a recess, or in a through-going opening being formed in the back protection panel; and
at least one airbag;
wherein the wearable safety system is configured to generate an activation signal upon detection of an accident, and
wherein the at least one airbag is configured to be inflated upon the generation of the activation signal and to be deployed to form at least one inflated body having an extension across at least one of the head and shoulders of the wearer, the thorax area of the wearer and the hips of the wearer.

Accordingly, a wearable safety system is provided that is embodied as a harness with two shoulder straps and a hip belt, whereby the wearable safety system may be worn on the torso of a wearer. Since the safety system relies on one or more inflatable airbags, there are no bulky protective panels that will restrict the wearers ordinary movements or choice of clothes. However, in the event an accident should be determined, the at least one airbag may be inflated and deployed to form an active protection across at least one of the head and shoulders of the wearer, the thorax area of the wearer and the hips of the wearer. In the event of several airbags, the safety system may be configured to determine which airbag or airbags should be inflated depending on the determined type of accident.

The at least one inflator may be configured to inflate one or more airbags. It is advantageous if the inflator is received in the recess or in the through-going opening to be substantially below or in level with one or both of two opposing major surfaces of the back protection panel.

The ECU and battery may be received in a recess, or a through-going opening being formed in the back protection panel. It is advantageous if the ECU and battery are received in the recess or in the through-going opening to be substantially below or in level with at least one the two opposing major surfaces of the back protection panel. It is preferred that the battery is arranged in such position that it is easy accessible from the exterior of the back protection panel to allow easy re-charging or replacement.

Accordingly, a wearable safety system is provided that is easy to wear and to adapt to the type of clothing and type of activity. Hence one and the same safety system may be used for a number of different types of daily activities, no matter if they are related to work, hobbies or sports.

The wearable safety system may in one embodiment comprise one airbag, said airbag being configured to be inflated and deployed to form an inflated body having an extension across the head and shoulders of the wearer, the thorax area of the wearer and the hips of the wearer. The spatial extension of the one airbag as seen in its inflated and deployed condition may be divided into different virtual zones having different thicknesses to thereby provide different types of cushioning effects across different areas of the wearers body. This effect may also be provided for by using seams and tethers.

The wearable safety system may in one embodiment comprise two airbags, wherein one airbag is configured to be inflated and deployed to form an inflated body having an extension across the head, shoulders and the thorax area of the wearer and one airbag is configured to be inflated and deployed to form an inflated body having an extension across the hips of the wearer.

The safety system may be configured to determine which of the two airbags should be inflated, or if both airbags should be inflated simultaneously depending on the determined type of accident. The spatial extension of the two airbags as seen in their inflated and deployed condition may be divided into different virtual zones having different thicknesses to thereby provide different types of cushioning effects across different areas of the wearers body.

The two airbags may be arranged in fluid communication with each other and be configured to be inflated by one single inflator. Alternatively, the two airbags may be discrete airbags and each airbag may be configured to be inflated by a respective inflator.

The wearable safety system may in one embodiment comprise three airbags, wherein one airbag is configured to be inflated and deployed to form an inflated body having an extension across the head, shoulders and thorax area of the wearer, and two airbags are configured to be inflated and deployed to form inflated bodies having an extension across the respective hips of the wearer. The safety system may be configured to determine which of the three airbags should be inflated, or if all airbags should be inflated simultaneously depending on the determined type of accident.

The three airbags may be arranged in fluid communication with each other and be configured to be inflated by one single inflator. Alternatively, the three airbags may be discrete airbags and each airbag may be configured to be inflated by a respective inflator.

The ECU and the one or more inflators may be arranged in a tamper-proof manner.

The wearable safety system may further comprise at least one movement sensor from a group consisting of a gyroscopic sensor and an accelerometer, and the ECU may be configured to determine, based on an input signal from the at least one sensor, existence of an accident and to generate the activation signal. The at least one movement sensor may be configured to communicate with the ECU in a wired or wireless manner.

The shoulder straps and/or the hip belt may each comprise a buckle arrangement with a buckle sensor, the sensor being configured to generate a coupling signal indicating if the wearable safety system is coupled or not to the body of the wearer by using the buckle arrangement. The buckle sensor may, as non-limiting examples, be in the form of a magnetic coupling that needs to be established by interconnecting components of the buckle arrangement, or in the form of a closed electric circuit that is established by interconnecting the components of the buckle arrangement. No matter configuration, the buckle sensor should be arranged in communication with the ECU, whereby the ECU may determine, based on the coupling signal, if the shoulder straps and hip belt are correctly fastened or not and hence if the wearable safety system is coupled or not to the body of the wearer by using the buckle arrangement. If determined to be correctly fastened, the wearable safety system may be set to an active mode, thereby allowing the inflator to be activated if necessary.

The at least one air bag may be integrated in the two shoulder straps and the hip belt. The airbag may be arranged inside the textile/material making up the shoulder straps and hip belt respectively. The airbag may be arranged in a rolled condition, in a folded condition or in a combined rolled and folded condition. The one or more airbags are preferably symmetrically integrated in the two shoulder straps and in the hip belt respectively as seen along a virtual symmetry line extending along a longitudinal centreline of the back protection panel.

The two shoulder straps and the hip belt may comprise one or more split lines configured to rupture during inflation of the at least one airbag. The split lines may be provided by locally weaker or locally thinner material. The one or more spilt lines may by way of example be formed as sewn seams, glued seams or welded seams.

The at least one airbag may be removably attached to the harness by means of at least one quick-coupling arrangement. Thereby the harness may be easily provided with a new airbag in the event of an accident resulting in an inflation. The useful life-length of the harness may thereby be prolonged.

The at least one airbag may comprise a first flap portion configured to, in a deployed condition, form an inflated body providing a protection to a first part of the wearer's body, and a second flap portion configured to, in a deployed condition, form an inflated body providing a protection to a second part of the wearer's body;

a connector of the first flap portion is connectable to a connector of the second flap portion; whereby, in a condition when the at least one airbag is deployed, the first and second inflated bodies are forced to jointly deploy and conform to and at least partly encircle the first and second parts of the wearer's body.

The first flap portion may be configured to provide a protection to the two shoulders of the wearers body, and the second flap portion may be configured to provide a protection to the thorax area of the wearers body.

The harness may be integral with, or be removably connectable to a bag, thereby forming a backpack. The harness may be configured to be removably connectable to one or more bags of different sizes and intended use. By making the bag(s) removably connectable, the harness may easily be converted from a stand-alone harness to a backpack at the wearer's discretion.

According to another aspect, a bag arrangement provided with a wearable safety system according to any of claims 1-14 is provided.

The wearable safety system as such and its advantages have been thoroughly described above. Those arguments are equally applicable to a bag using such wearable safety system. The bag may be configured as a backpack. Alternatively, the bag may be configured to be worn on the hip, chest or waist. Thus, in order of avoiding undue repetition, reference is made to the sections above.

### BRIEF DESCRIPTION OF THE DRAWINGS

The disclosure will be described in more detail with reference to the appended schematic drawings, which show examples of a presently preferred embodiment of the disclosure.

FIG. 1 is a highly schematic illustration of a wearable safety system according to one embodiment of the invention.

FIG. 2 is a highly schematic illustration of the interior design of one embodiment of the harness forming part of the wearable safety system.

FIG. 3 is a highly schematic illustration of the interior design of one embodiment of the harness forming part of the wearable safety system.

FIGS. 4a and 4b are highly schematic illustrations of one embodiment of the wearable safety system during ordinary use and with the airbag in an inflated and deployed condition.

FIGS. 5a and 5b are highly schematic illustrations of one embodiment of the wearable safety system during ordinary use and with the airbag in an inflated and deployed condition covering the head and shoulders.

FIGS. 6a and 6b are highly schematic illustrations of one embodiment of the wearable safety system during ordinary use and with the airbag in an inflated and deployed condition covering the thorax area.

FIGS. 7a and 7b are highly schematic illustrations of one embodiment of the wearable safety system during ordinary use and with the airbag in an inflated and deployed condition covering the hips.

FIG. 8 is a highly schematical view of one embodiment of the wearable safety system converted into a backpack with two bags.

FIG. 9 is a highly schematical view of one embodiment of the wearable safety system supporting bags on the back and on the front of the harness.

FIGS. 10a and 10b disclose, highly schematically, one example where the at least one airbag is removably attached to the harness by means of a quick-coupling arrangement.

FIGS. 11a and 11b disclose one embodiment where connectors are used to control the overall shape of the at least one airbag in its deployed condition.

### DETAILED DESCRIPTION

The present disclosure will now be described more fully hereinafter with reference to the accompanying drawings, in which currently preferred embodiments of the disclosure are shown. The present disclosure may however be embodied in many different forms and should not be construed as limited to the embodiments set forth herein. Rather, these embodiments are provided for thoroughness and completeness, and to fully convey the scope of the disclosure to the skilled addressee. Like reference characters refer to like elements throughout.

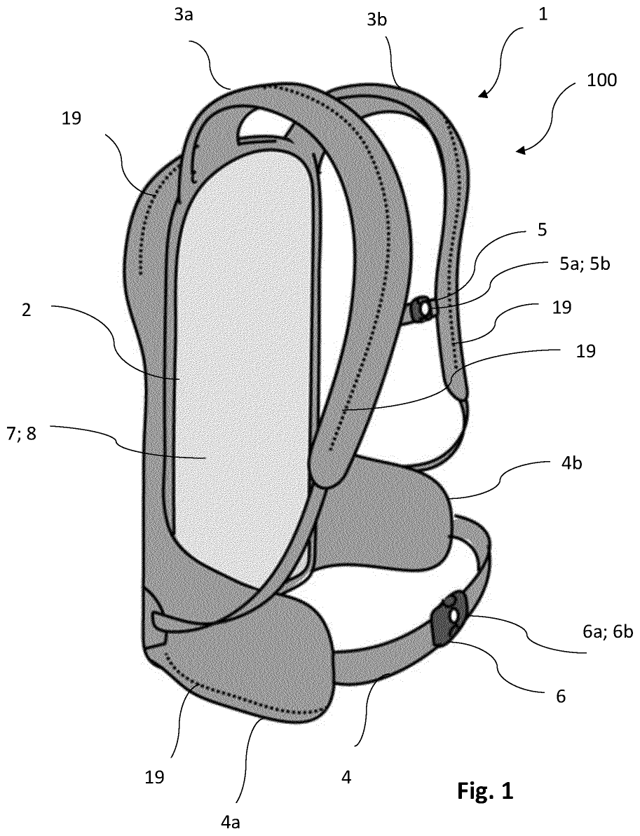

Starting with FIG. 1, one schematic illustration of one embodiment of the wearable safety system 100 in the form of a harness 1 is provided.

The harness 1 comprises a back wall 2 configured to face the wearer's back, two shoulder straps 3a, 3b which are connected to the back wall 2 at an upper and a lower edge portion thereof, and a hip belt 4 in the form of two flanks 4a, 4b that are connected to the lower edge of back wall 2. The harness 1 is configured to be supported on and coupled to the wearer's torso when in use.

The back wall 2, the two shoulder straps 3a, 3b and the hip belt 4 may be provided with a suitable padding (not illustrated) on surfaces configured to face the body of the wearer. The harness may be provided by any suitable material such as a wear and water-resistant material.

The two shoulder straps 3a, 3b are provided with a buckle arrangement 5. The buckle arrangement 5 comprises a first and a second buckle member 5a, 5b that are configured to be interlocked across the chest area or the wearer during use of the harness 1.

The two flanks 4a, 4b of the hip belt 4 are provided with a buckle arrangement 6 comprising a first and a second buckle member 6a, 6b that are configured to be interlocked across the hips of the wearer during use of the harness 1.

By the buckle arrangements 5, 6, the harness may be securely coupled to the wearer's torso when in use.

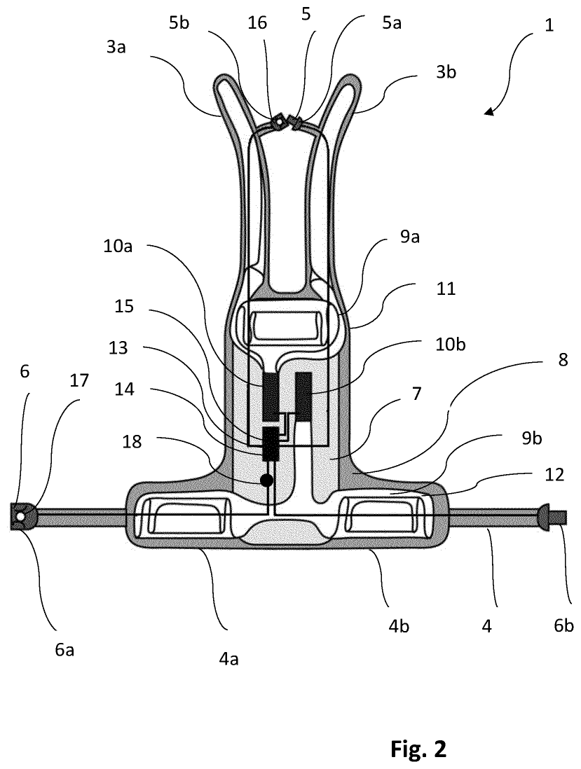

The back wall 2 comprises a back protection panel 7. The back protection panel 7 which is best seen in FIG. 2, is preferably encapsulated in a protective cover 8 of the harness. The cover may be made tamper-proof. The back protection panel 7 is a rigid panel having an extension along the longitudinal extension of the back wall 2. The back protection panel 7 may be formed of a plastic material, a composite material or a light-weight metallic material. The back protection panel 7 provides an overall structure to the harness 1. Further, the back protection panel 7 may provide a spinal protection in the event of an accident.

Now turning to FIG. 2, a highly schematic illustration of the interior design of one embodiment of the harness 1 forming part of the wearable safety system 100 is disclosed. The disclosed harness 1 comprises two discrete airbags 9a, 9b and two inflators 10a, 10b.

The first airbag 9a is encapsulated in a folded and/or rolled condition in a compartment 11 which has an extension across an upper portion of the back wall 2 and along the two shoulder straps 3.

The first airbag 9a is arranged in communication with the first inflator 10a which is supported by the back protection panel 7. The first airbag 9a is in an inflated and deployed condition configured to provide a protection across the head and shoulders of the wearer and also across the thorax area of the wearer as will be described below. The first airbag 9a is arranged in communication with an opening of the first inflator 10a.

The second airbag 9b is encapsulated in a folded and/or rolled condition in a compartment 12 which has an extension along the two flanks 4a, 4b of the hip belt 4. The second airbag 9b is arranged in communication with the second inflator 10b which is supported by the back protection panel 7. The second airbag 9b is in an inflated and deployed condition configured to provide a protection across the hips. The second airbag 9b is arranged in communication with an opening of the second inflator 10b.

The airbags 9a, 9b which as such are well known in the art may be made of a flexible fabric material. The material may be a textile material such as a woven or non-woven material. The material may be plastic or composite material. The airbag may be provided with tethers (not illustrated) and other types of elements to control the deployment. Such control is well known in the art of airbags and is not further discussed.

The skilled person realizes that the folding and/or rolling of the airbags 9a, 9b may be made in a number of ways with remained function, where the folding pattern is adapted to the overall geometry of the airbags and to their intended deployment.

The airbags 9a, 9b are preferably symmetrically integrated in the two shoulder straps 3a, 3b and in the two flanks 4a, 4b of the hip belt 4 as seen along a virtual symmetry line extending along a longitudinal centreline of the back protection panel 7.

The back protection panel 7 supports an ECU 13 (Electronic Control Unit) and a battery 14. The ECU 13 which comprises a processor (not illustrated) is arranged in communication with the respective inflator 10a, 10b. The inflators 10a, 10b, which as such are well known in the art of airbag systems, may each comprise a gas generator (not illustrated). The inflators 10a, 10b are configured to be connected to the ECU 13 and to be activated based on an activation signal which is indicating an accident.

The ECU 13, the inflators 10a, 10b and the battery 14 may be received in one or more recesses 15, or through-going openings which are formed in the back protection panel 7. It is advantageous if the ECU 13, the inflators 10a, 10b and the battery 14 are received in the one or more recesses 15 or through-going openings to be substantially below or in level with at least one two opposing major surfaces of the back protection panel 7. Thereby, there are no parts protruding from the back protection panel 7.

The one or more recesses 15 or through-going openings 15 may also be configured to receive at least a portion of the one or more airbags 9a, 9b.

It is preferred that the battery 14 is arranged in such position that it is easy accessible from the exterior of the back protection panel 7 to allow easy re-charging or replacement. Access to the battery 14 may be provided for via a non-illustrated re-closable opening in the cover 8. It is preferred that the inflator(s), the ECU and the airbag(s) are arranged in a tamper-proof manner.

As given above, the shoulder straps 3a, 3b and the hip belt 4 do each comprise a buckle arrangement 5, 6. Each buckle arrangement 5, 6 may comprise a sensor, in the following referred to as a buckle sensor 16, 17. The buckle sensors 16, 17 are configured to generate a coupling signal indicating if the wearable safety system 100 is coupled or not to the torso of the wearer by using the buckle arrangements 5, 6. The buckle sensors 16, 17 may, as non-limiting examples, be in the form of a magnetic coupling that needs to be established by interconnecting the buckle members 5a, 5b; 6a, 6b of the buckle arrangements 16, 17, or in the form of a closed electric circuit that is established by interconnecting the buckle members 5a, 5b; 6a, 6b. No matter configuration, the buckle sensor(s) 16, 17 are arranged in communication with the ECU 13. The buckle sensors 16, 17 may be configured to communicate with the ECU 13 in a wired or wireless manner. The ECU 13 may be configured to determine, based on the coupling signal, if the shoulder straps 3a, 3b and hip belt 4 are correctly fastened or not and hence if the wearable safety system 100 is coupled or not to the body of the wearer by using the buckle arrangements 5, 6. If determined to be correctly fastened, the wearable safety system 100 may be set to an active mode, thereby allowing the inflators 10a, 10b to be activated if necessary.

Further, the wearable safety system 100 comprises at least one movement sensor 18 from a group consisting of a gyroscopic sensor and an accelerometer. The at least one movement sensor 18 is configured to communicate with the ECU in a wired or wireless manner. The at least one movement sensor 18 may be arranged in any suitable position on the harness 1.

The ECU 13 is configured to determine, based on an input signal from the at least one movement sensor 18, existence of an accident and to generate an activation signal. An accident may be determined to occur in the event the one or more movement sensors 18 indicate a movement or acceleration that alone or in combination exceeds a pre-determined threshold value. The ECU 13 may be configured to determine and control the activation of the at least one inflator 10a, 10b to thereby inflate and deploy the one or more airbags 9a, 9b. The ECU 13 may be configured to determine which of the airbags 9a, 9b should be inflated, or if all airbags 9a, 9b should be inflated simultaneously depending on the determined type of accident.

In the event a processor of the ECU 13, based on collected and processed signals from the at least one movement sensor 18 should determine that there is a accident, an activation signal will be communicated to the respective inflator 9a, 9b. Based on this activation signal, the respective gas generator is activated and generates a gas flow which inflates the airbag 9a, 9b. The airbag 9a, 9b is deployed to form at least one inflated body having an extension across at least one of the head and shoulders of the wearer, the thorax area of the wearer and the hips of the wearer.

As is best seen in FIG. 1, an upper portion of the back wall 2, the two shoulder straps 3a, 3b and the two flanks 4a, 4b of the hip belt 4 comprise split lines 19. The split lines 19 are schematically illustrated by dashed lines. The split lines 19 are configured to rupture during inflation of the at least one airbag 9a, 9b. The split lines 19 may be provided by locally weaker material or locally thinner material. The one or more spilt lines 19 may be formed as sewn seams, adhesive seams or welded seams.

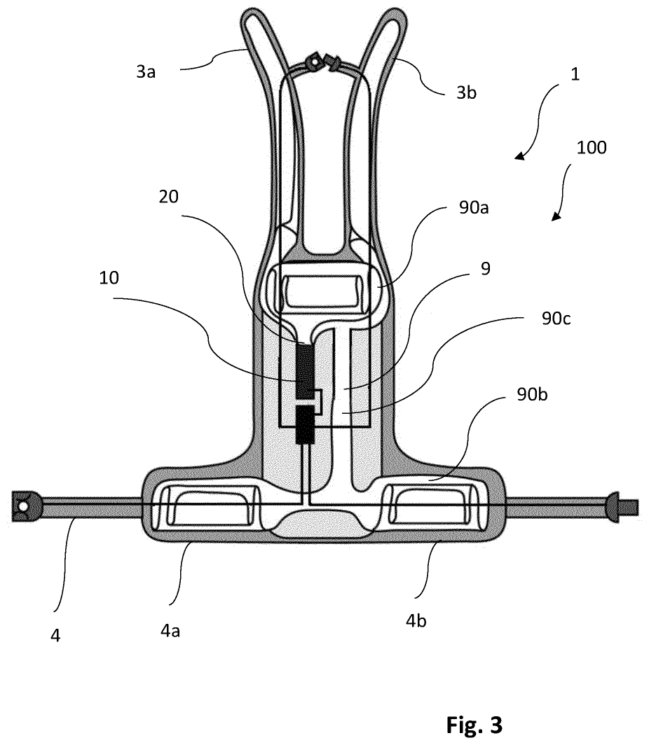

Now turning to FIG. 3, an alternative embodiment of the wearable safety system 100 is disclosed. The wearable safety system 100 comprises a harness 1 that has the same overall design as that previously described with reference to FIGS. 1 and 2. As a difference, the harness 1 comprises one airbag 9 and one inflator 10.

The airbag 9 is encapsulated in a folded and/or rolled condition in a compartment which has an extension across an upper portion of the back wall 2 and along the two shoulder straps 3a, 3b and also along the two flanks 4a, 4b of the hip belt 4. The airbag 9 is arranged in communication with the inflator 10. The inflator 10 is arranged in a substantially central position in view of the airbag 9. A first portion 90a of the airbag 9 is configured to, as seen in an inflated and deployed condition, provide a protection across the head and shoulders of the wearer and also across the thorax area of the wearer. A second portion 90bof the airbag 9 is configured to, as seen in an inflated and deployed condition, provide a protection across hips of the wearer.

The two airbag portions 90a, 90b are illustrated as being in fluid communication with each other. The communication is provided for via a channel-like extension 90c. The channel-like extension 90c is illustrated as being separate from the inflator 10. The skilled person realizes that the two airbag portions 90a, 90b with remained function may be arranged to communicate with each other directly via the outlet 20 of the inflator 10.

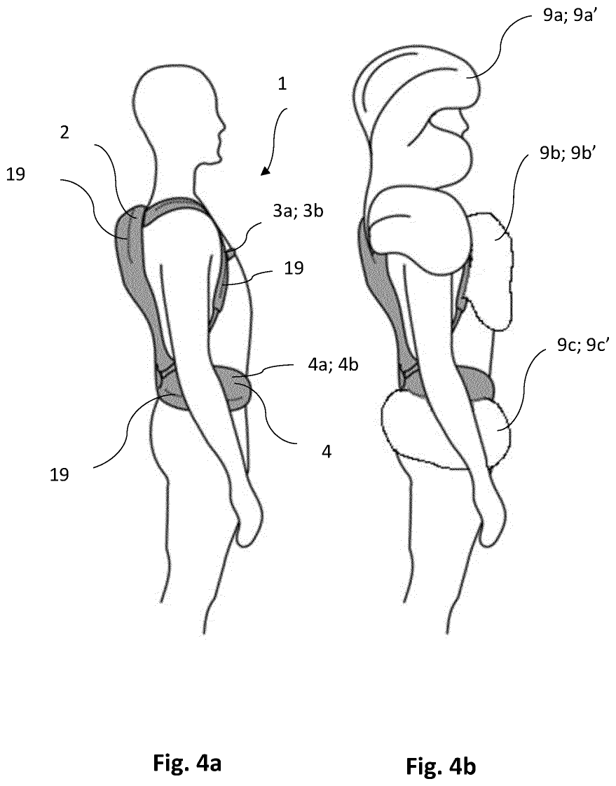

Now turning to FIGS. 4a and 4b, one embodiment of the wearable safety system 100 which is configured to protect the head and shoulder area, the thorax area and the hips is disclosed. The harness 1 may be of the same type that has been described above with reference to FIGS. 1-3 and comprise one single airbag 9 or be divided into two or more, such as three, discrete airbags 9a-9c. In the event of one single airbag 9, this may in turn be arranged into three airbag portions 9a′-9c′. In case of two or more discrete airbags 9a-9c, these may be configured to be inflated by a single inflator or by two or more discrete inflators.

The airbag(s) is/are during ordinary use contained, see FIG. 4a, in an upper portion of the back wall 2 of the harness 1, along the shoulder straps 3a, 3b and along the flanks 4a, 4b of the hip belt 4. The at least one inflator is concealed in the interior of the harness and is hence omitted.

The airbag(s) 9a-9c; 9a′-9c′ is/are configured to be inflated and deployed, see FIG. 4b, to provide a partial encapsulation of the head and cheek area, across the shoulders, across the thorax area and also across the hips. The deployment may be controlled by the seams (not illustrated) of the airbag(s) but also by one or more tethers (not illustrated) inside the airbag(s). To allow this kind of deployment, the material in the cover of the back wall 2, the shoulder straps 3a, 3b and the hip belt 4 may be provided with one or more split lines 19, whereby the material will rupture in a controlled manner as the airbag(s) is/are inflated.

The material making up the harness may be configured, upon an activation of the inflator, to rupture along the split lines 19, thereby forming a flap like deflector (not illustrated). The deflector may be configured to guide the deployment of the airbag(s) 9a-9cin a certain direction, such as upwardly to protect the head or downwardly to protect the hips.

The spatial extension of the airbag(s) 9a-9c; 9a′-9c′ as seen in its inflated and deployed condition may be divided into different virtual zones having different thicknesses to thereby provide different types of cushioning effects across different areas of the wearers body. This effect may be provided for by using seams and tethers.

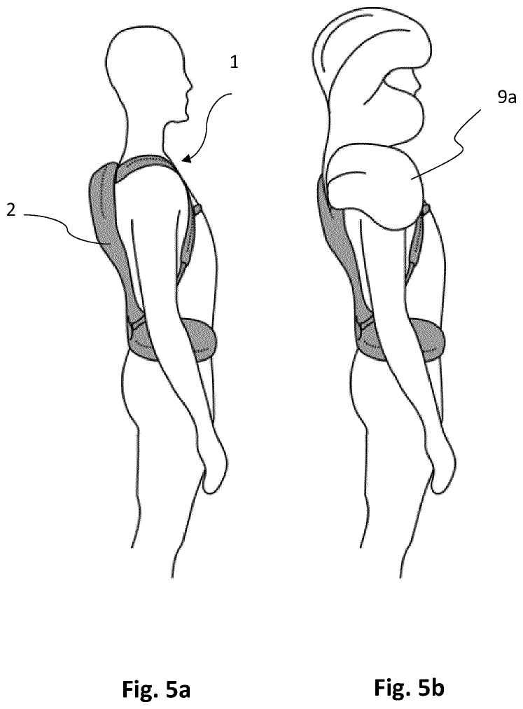

Now turning to FIGS. 5a and 5b, one embodiment of the airbag 9a which is configured to protect the head and shoulder area is disclosed. The airbag 9a is preferably contained in an upper portion of the back wall 2 of the harness 1, see FIG. 5a. As the airbag is inflated it may be deployed to provide a partial encapsulation of the head and cheek area and also across the shoulder portion of the wearer, see FIG. 5b.

The skilled person realises that the airbag that is configured to protect the head and shoulders with remained function may be divided into two or even more discrete airbags. Such discrete airbags may be configured to be inflated by one or more inflators.

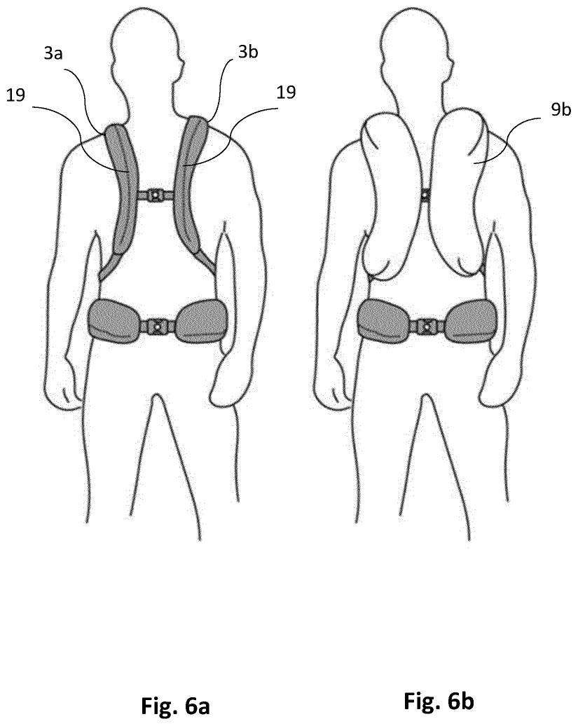

Now turning to FIGS. 6a and 6b, one embodiment of the airbag 9b which is configured to protect the thorax area is disclosed. The airbag 9b is preferably contained in the two shoulder straps 3a, 3b, see FIG. 6a. As the airbag 9b is inflated it may be deployed to provide two inflated portions that each have an extension along the longitudinal extension of the respective shoulder strap, see FIG. 6b. To allow this kind of deployment, the material in the front side of the respective shoulder strap may be provided with one or more split lines 19, whereby the material will rupture in a controlled manner as the airbag is inflated.

The skilled person realises that the airbag that is configured to protect the thorax area with remained function may be divided into two discrete airbags. In case of two discrete airbags protecting the thorax area, these may be configured to be inflated by one single inflator or by separate inflators.

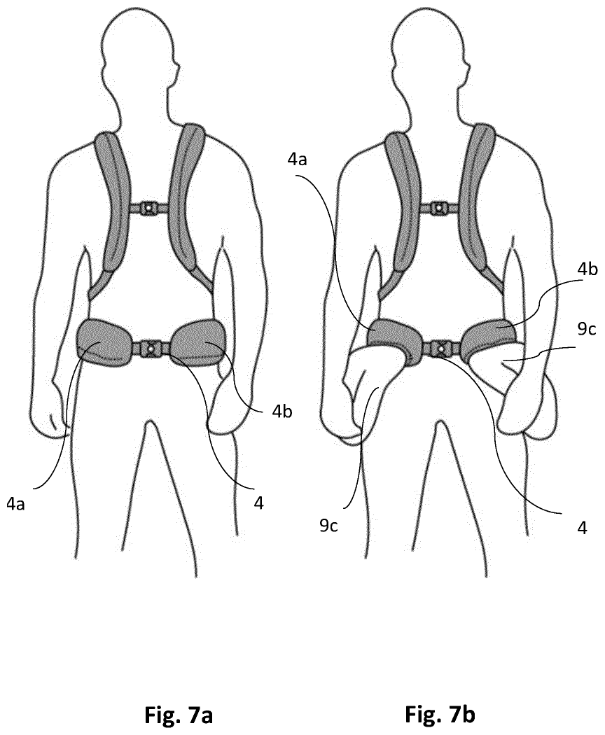

Now turning to FIGS. 7a and 7b, one embodiment of the airbag 9c which is configured to protect the hips is disclosed. The airbag 9c is preferably contained in the two flanks 4a, 4b of the hip belt 4, see FIG. 7a. As the airbag 9c is inflated it may be deployed to provide two inflated portions 9c that each have an extension along the longitudinal extension of the respective flank 4a, 4b of the hip belt 4, see FIG. 7b.

The skilled person realises that the airbag 9c that is configured to protect the hips with remained function may be divided into two discrete airbags, one in each flank of the hip belt. In case of two discrete airbags protecting the hip belt, these may be configured to be inflated by one single inflator or by separate inflators.

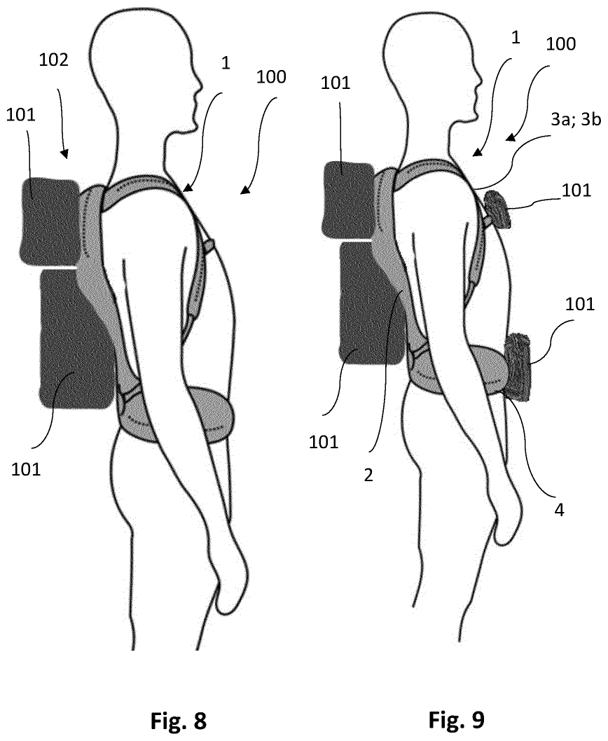

Now turning to FIG. 8, the wearable safety system 100 may in one embodiment be provided as a backpack 102. The harness 1 may be integral with or be removably connectable to one or more bags 101. The backpack 102 is disclosed with two bags 101 having different sizes, volumes and intended use. By making the bag(s) 101 removably connectable, the harness 1 may easily be converted from a stand-alone harness 1 to a backpack 102 at the wearer's discretion. The bags 101 may be removably connectable by using e.g., one or more (non-illustrated) straps or buckles.

Now turning to FIG. 9, the wearable safety system 100 may in one embodiment be provided with bags 101. The harness 1 may be integral with or be removably connectable to one or more bags 101. In the disclosed embodiment, the harness 1 is provided with two bags 101 connected to the back portion 2, one bag 101 connected to the shoulder straps 3a, 3b and one bag 101 connected to the hip belt 4. The bags 101 may have different sizes, volumes and intended use. The one or more bags may be configured to be worn on the back, the hips, chest or waist.

By making the one or more bags 101 removably connectable, the harness 1 may easily be converted from a stand-alone harness 1 to a bag supporting harness at the wearer's discretion. The bags 101 may be removably connectable by using e.g., one or more (non-illustrated) straps or buckles.

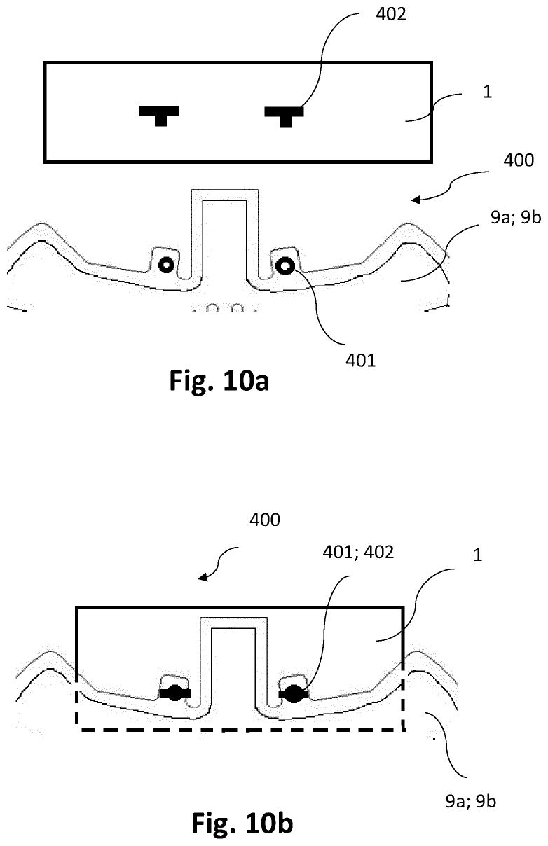

Now turning to FIGS. 10a and 10b. The at least one airbag 9a, 9b has been exemplified above as being fixedly arranged to the harness 1. However, in the event of an accident causing a deployment of the airbag, it is difficult to replace the used airbag with a new airbag and thereby allow a re-use of the harness.

FIGS. 10a and 10b disclose, highly schematically, one example where the at least one airbag 9a, 9b is removably attached to the harness 1 by means of a quick-coupling arrangement 400. In the disclosed embodiment, the at least one airbag 9a, 9b is provided with eyelets forming female connectors 401, and the harness 1 is provided with T-shaped projections forming male connectors 402. The reversed positions of the male and female connectors 401, 402 may be equally applied. To attach the airbag 9a, 9b to the harness 1, the T-shaped projections are inserted into a respective eyelet. To remove the airbag 9a, 9b, if necessary, the reversed order is performed. The skilled person realizes that the number of quick-coupling arrangements 400 in the harness 1 and the airbag 9a, 9b, and their positions depend on the overall shape of the airbag to be connected and the harness and also the design of the harness. The positions and number of quick-coupling arrangements 400 attaching the airbag 9a, 9b to the harness 1 can be used to control the overall shape of the at least one airbag in its deployed condition. The skilled person realizes that the quick-coupling arrangement 400 can have another configuration than a T-shaped projection in combination with an eyelet. Non-limiting examples are one or more snap fasteners, also known as poppers, straps or strips of Velcro®.

The very same principle may be used to connect the at least one airbag to other portions of the harness, such as to the shoulder straps or the hip belt.

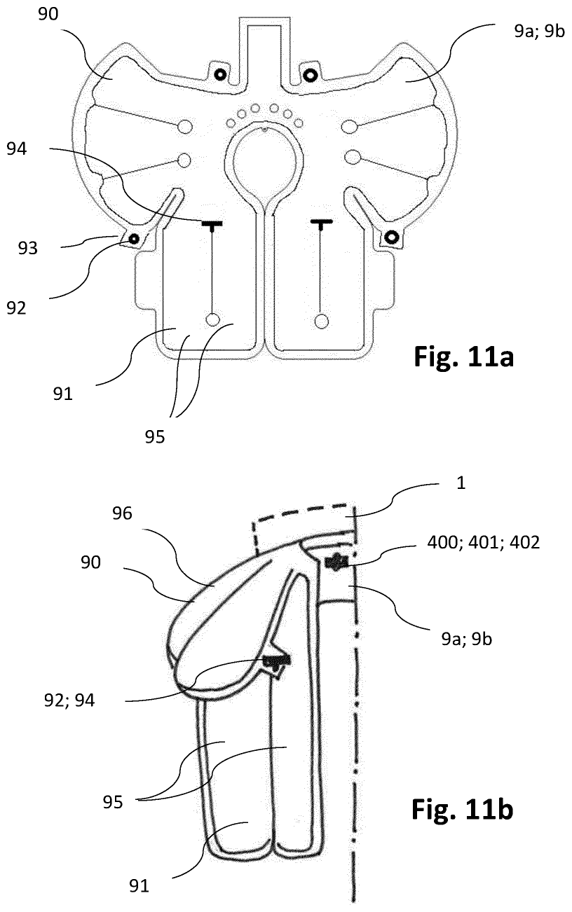

Now turning to FIGS. 11a and 11b, one embodiment is disclosed where connectors are used to control the overall shape of the at least one airbag 9a, 9b in its deployed condition.

Starting with FIG. 11a, one example of an airbag 9a, 9b in its flat, unrolled condition is disclosed. The airbag 9a, 9b is specifically configured to provide a support for the shoulders and the thorax area. The airbag 9a, 9b comprises a first flap portion 90 and a second flap portion 91. The first flap portion 90 is configured to, in a deployed condition, form an inflated body that provides a protection to a first part of the wearer's body, namely the shoulders. The second flap portion 91 is configured to, in a deployed condition, form an inflated body that provides a protection to a second part of the wearer's body, namely the thorax area. No matter design, the airbag 9a, 9b has a design that as such is well known in the art by being divided into different bodies by seams or weld lines.

The first flap portion 90 comprises, on opposite sides of a longitudinal centerline, two female-type connectors 92. The female-type connectors 92 are arranged in a respective tab 93 that is arranged along the outer edge of the airbag 9a, 9b. Correspondingly, the second flap portion 91 comprises, on opposite sides of the longitudinal centerline, two male-type connectors 94. The connectors 92, 94 are disclosed as being arranged in an area that as such is not to be inflated. Thus, in the event the second flap portion 91 is divided into two bodies 95 to be inflated, the male-type connectors 94 are arranged in an area between two such bodies 95. This allows a stronger attachment of the connectors.

Now turning to FIG. 11b which highly schematically discloses the airbag 9a, 9b in an inflated and deployed condition and removably attached to a rear wall of a harness 1. The disclosed arrangement is mirror symmetric about the longitudinal centerline and only one side is illustrated.

The harness 1 is very schematically disclosed by dashed lines. The shoulder straps have been omitted. The airbag 9a, 9b as such is removably attached to the harness 1 by a quick-coupling arrangement 400 of the same type that was discussed above with reference to FIGS. 9a and 9b. Thus, the airbag 9a, 9b is provided with eyelets forming female-type connectors 401, and the harness 1 is provided with T-shaped projections forming male-type connectors 402. To attach the airbag 9a, 9b to the harness 1, the T-shaped projections are inserted into their respective eyelets. To remove the airbag, if necessary, the reversed order is performed.

Further, the first flap portion 90 that in its deployed condition is configured to provide a shoulder protection is folded over and connected to the second flap portion 91 that in its deployed condition is configured to provide a protection to the thorax area. The connection is provided for by the female-type connector 92 of the first flap portion 90 engaging the male-type connector 94 of the second flap portion 91. In the event of an accident which causes the airbag 9a, 9b to inflate and deploy, the interconnection between the two flap portions 90, 91 results in that the resulting two inflated bodies 95, 96 are forced to jointly deploy and conform to and at least partly encircle the first and second parts of the wearer's body. Thus, the shoulders and the thorax area will be efficiently protected.

The very same principle of using connectors to force different inflated bodies to jointly conform is applicable to also other body parts of the wearer.

The skilled person understands that the male-type connectors 94 in the second flap portions 91 of the airbag 9a, 9b may be replaced by female-type connectors of the same type that are arranged in the first flap portions 90, and that the harness, such as its shoulder straps, are provided with a male-type connector, The airbag can then be removably attached to the harness while at the same time also connecting the first flap portion 91 to the second flap portion 92 as is described above and as is illustrated in FIG. 11b.

The skilled person realises that a number of modifications of the embodiments described herein are possible without departing from the scope of the disclosure, which is defined in the appended claims.

By way of example, the material of the one or more airbags, may be configured to be stretched during the deployment. The stretching will add an overall stiffness to the inflated airbag. This may be provided for by using different material types/properties in the airbag as a whole or in local surface areas of the airbag.

Although the airbag has been exemplified as being arranged in the harness in a rolled condition or folded condition, the skilled person realizes that other patterns or combinations of different patterns may be used. No matter how the airbag is packed in the harness, it is preferred that the airbag(s) is/are symmetrically arranged in the harness.

1. A wearable safety system, comprising:
a harness comprising a back protection panel, two shoulder straps and a hip belt, said harness being configured to be worn on the torso of a wearer; wherein,
the back protection panel is formed by a rigid material and has an extension along the longitudinal extension of a back wall of the harness;
the back protection panel supports at least one inflator, an ECU and a battery, said ECU being arranged in communication with the at least one inflator;
the at least one inflator is received in a recess, or in a through-going opening being formed in the back protection panel; and
at least one airbag;
wherein the wearable safety system is configured to generate an activation signal upon detection of an accident, and
wherein the at least one airbag is configured to be inflated upon the generation of the activation signal and to be deployed to form at least one inflated body having an extension across at least one of the head and shoulders of the wearer, the thorax area of the wearer and the hips of the wearer.

2. The wearable safety system according to claim 1, wherein the wearable safety system comprises one airbag, said airbag being configured to be inflated and deployed to form an inflated body having an extension across the head and shoulders of the wearer, the thorax area of the wearer and the hips of the wearer.

3. The wearable safety system according to claim 1, wherein the wearable safety system comprises two airbags, wherein one airbag is configured to be inflated and deployed to form an inflated body having an extension across the head, shoulders and the thorax area of the wearer and one airbag is configured to be inflated and deployed to form an inflated body having an extension across the hips of the wearer.

4. The wearable safety system according to claim 3, wherein the two airbags are arranged in fluid communication with each other and are configured to be inflated by one single inflator; or
wherein the two airbags are discrete airbags and each airbag is configured to be inflated by a respective inflator.

5. The wearable safety system according to claim 1, wherein the wearable safety system comprises three airbags, wherein
one airbag is configured to be inflated and deployed to form an inflated body having an extension across the head, shoulders and thorax area of the wearer, and two airbags are configured to be inflated and deployed to form inflated bodies having an extension across the respective hips of the wearer.

6. The wearable safety system according to claim 5, wherein the three airbags are arranged in fluid communication with each other and are configured to be inflated by one single inflator; or
wherein the three airbags are discrete airbags and each airbag is configured to be inflated by a respective inflator.

7. The wearable safety system according to claim 1, wherein the system comprises one inflator, and wherein the one inflator is configured to inflate one or more airbags.

8. The wearable safety system according to claim 1, further comprising at least one movement sensor from a group consisting of a gyroscopic sensor and an accelerometer, and wherein the ECU is configured to determine, based on an input signal from the at least one movement sensor, existence of an accident and to generate the activation signal.

9. The wearable safety system according to claim 1, wherein the shoulder straps and/or the hip belt each comprises a buckle arrangement with a buckle sensor, the buckle sensor being configured to generate a coupling signal indicating if the wearable safety system is coupled or not to the body of the wearer by using the buckle arrangement.

10. The wearable safety system according to claim 1, wherein the at least one airbag is integrated in one or more of an upper end portion of a back wall of the harness, the two shoulder straps and the hip belt.

11. The wearable safety system according to claim 10, wherein the two shoulder straps and the hip belt comprise one or more split lines configured to rupture during inflation of the at least one airbag.

12. The wearable safety system according to claim 1, wherein the at least one airbag is removably attached to the harness by means of at least one quick-coupling arrangement.

13. The wearable safety system according to claim 1, wherein:
the at least one airbag comprises a first flap portion configured to, in a deployed condition, form an inflated body providing a protection to a first part of the wearer's body, and a second flap portion configured to, in a deployed condition, form an inflated body providing a protection to a second part of the wearer's body;
a connector of the first flap portion is connectable to a connector of the second flap portion; whereby, in a condition when the at least one airbag is deployed, the first and second inflated bodies are forced to jointly deploy and conform to and at least partly encircle the first and second parts of the wearer's body.

14. The wearable safety system according to claim 1, wherein the harness is integral with or is removably connectable to a bag, thereby forming a backpack.

15. A bag arrangement provided with the wearable safety system according to claim 1.
